(19) United States
(12) Patent Application Publication
(10) Pub. No.: US 2025/0291353 A1
(43) Pub. Date: Sep. 18, 2025

(54) DESIGN AND CONTROL OF WHEEL-LEGGED ROBOTS NAVIGATING HIGH OBSTACLES

(71) Applicant: University of Southern California, Los Angeles, CA (US)

(72) Inventors: Quan Nguyen, Los Angeles, CA (US); Junheng Li, Los Angeles, CA (US); Junchao Ma, Los Angeles, CA (US)

(21) Appl. No.: 18/858,898

(22) PCT Filed: Apr. 21, 2023
(86) PCT No.: PCT/US2023/066053

§ 371 Date: Oct. 22, 2024

Related U.S. Application Data
(60) Provisional application No. 63/333,850, filed on Apr. 22, 2022.

(51) Int. Cl. G05D 1/495; B62D 57/024; B62D 57/028; G05D 1/49; G05D 1/622; G05D 1/644; G05D 109/12; G05D 109/15

(52) U.S. Cl. CPC G05D 1/495; B62D 57/024; B62D 57/028; G05D 1/498; G05D 1/622; G05D 1/644; G05D 2109/12; G05D 2109/15

(57) ABSTRACT

Methods and systems are provided for controlling wheel-legged quadrupedal robots using pose optimization and force control according to quadratic programming (QP) are disclosed. An example robotic system leverages the whole-body motion and the wheel actuation to roll over high obstacles while keeping the wheel torques to navigate the terrain. Wheel traction and balancing is employed for the robot body. Linear rigid body dynamics with wheels are used for real-time balancing control of wheel-legged robots. Further, an effective pose optimization method is implemented for locomotion over steep ramp and stair terrains. The pose optimization solves for optimal poses to enhance stability and enforce collision-fee constraints for the rolling motion over stair terrain.

### PRIORITY CLAIM

The present disclosure claims the priority to and benefit of U.S. Provisional Application Ser. No. 63/333,850, filed Apr. 22, 2022. The contents of that application are hereby incorporated by reference in their entirety.

### TECHNICAL FIELD

The present application generally relates to systems and methods for controlling and designing wheel-legged robots.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

The recent technological and theoretical developments in both robot design and controls have allowed the world to witness many successful and highly autonomous legged robots. With such hardware and software advancements, researchers in the robotics field are now facing a challenge to develop mobile legged robots that can conduct given tasks fully autonomously. Another challenge is providing a control framework that can perform robustly in terrains with uneven surfaces with obstacles.

In many real-life applications, robots are required to complete long-range operations over complex terrains with high energy efficiency. No single locomotion mechanism is ideally suited for this combination of requirements. Many bipedal and quadruped robots have demonstrated outstanding maneuverability and dynamic locomotion in unknown terrain over the last decade. These robots have proven to have great potential to be controlled autonomously. However, energy efficiency in the robot hardware remains one of the most important conditions that determines whether a mobile robot can perform real-life tasks that require extended periods of time while maintaining highly dynamical locomotion, such as for rescue and disaster-response missions. Legged robots rely on a gait sequence and proper foot placement to overcome obstacles and uneven surfaces. Due to their morphology, legged robots have a unique capability to navigate rough terrain. They can leverage different gait sequences by lifting and swinging certain legs while walking to place their feet in strategic positions and overcome high obstacles or uneven surfaces. Legged robots have also demonstrated the ability to jump onto an obstacle three or four times higher than their body height. However, while legged robots have advantages in navigating uneven terrain, they are not reliable at achieving high speeds and not energy efficient in traveling for long distances. Wheeled robots, in contrast, are generally much more energy efficient and capable of faster speeds on an even surface or flat ground. However, robots with only wheels have a very limited capability in navigating rough terrains. Therefore, methods and systems are provided herein for designing, operating, determining motion planning for and/or controlling a highly dynamic wheel-legged quadrupedal robot, a hybrid system of both wheels and legs that could leverage the advantages from both worlds. The wheel-legged robot described herein may run and jump over extreme terrain at high speed with high energy efficiency. Using legs for robots is a more effective method in rough terrain locomotion compared to only wheeled systems. However, wheeled systems generally require far less energy consumption and have faster speed to maneuver on an even surface.

In one example approach for the control of wheel-legged robots is a wheel-legged quadruped robot, ANY-mal, that utilizes a kinodyanmics model in whole-body model-predictive control for robust locomotion control. In another approach, the wheel-legged bipedal robot, Ascento, adopts the whole-body dynamics by using a linear-quadratic regulator (LQR) and Zero-moment point (ZMP) in balance control.

Further, force-based quadratic programming (QP) balancing control has been implemented on the MIT quadruped robot Cheetah 3 and allows the robot to balance even after performing very dynamical and aerial tasks, such as jumping. Modifying simplified dynamics in a QP balance controller has also gained success in controlling mobile legged robots. Trajectory optimization frameworks in motion planning have allowed legged robots to achieve dynamic locomotion. For example, certain robots utilize a nonlinear programming problem (NLP) solver to find optimal trajectories for a certain task. However, one important constraint in such optimization frameworks is the utilization of robot dynamics, either full body dynamics or simplified centroidal dynamics. Hence, a hybrid system of both wheels and legs leverages the advantages from both worlds, enabling maneuverability in rough terrain, energy efficiency, and speed.

Thus, there is a need for a robot that utilizes both the advantages of legs and wheels for traversing terrain with obstacles. There is a further need for a control system that allows pose optimization for a robot to navigate large obstacles in a terrain with minimal computational costs. There is also a need for a simplified combined control system for a robot with wheel-legs.

### SUMMARY

Systems and methods for wheel-legged robot design and control are disclosed to address the above needs. In one example, a method for controlling wheel-legged robot leverages the wheel traction to traverse challenging terrains (i.e., instead of stepping over a high obstacle, the whole body motion and wheel actuation are leveraged to roll over the obstacle). The obstacle height a legged robot can step over is limited. In contrast, the example control method described herein allows the robot to roll over an obstacle that is higher than the robot's nominal standing height. Further, the method described herein includes performing pose optimization to solve for optimal and collision-free poses for the robot rolling up high stairs or other obstacles.

An example control paradigm provided herein for wheel-legged robots considers the wheel dynamics and terrain slope in the model. The control paradigm is also adopted for the rolling task instead of just a standing balance.

Further, while the previous approaches in motion planning of a wheel-legged robot utilize either full body dynamics or simplified centroidal dynamics, an example approach with pose optimization described herein uses kinematic constraints instead to guarantee collision-free terrain navigation and solves for favorable configurations to maintain balance. The advantage of the example pose optimization framework is that the robot can leverage and adapt to the shape and height of the obstacle to overcome the obstacle rather than simply stepping or rolling over it. Thus, the pose optimization framework allows the robot to overcome an obstacle with a height that exceeds its nominal standing height. Further, in the pose optimization framework, dynamics or Inverse Kinematics (IK) are not used to solve for joint angles by relative foot position (i.e., the technique used by kinodynamics models). Instead, the pose optimization framework directly uses joint angles, body center of mass (CoM) location in 2D, and body pitch angle as the only optimization variables. The example pose optimization also uses Forward Kinematics (FK) to constrain the relative foot position and collision-avoidance in a favorable pose, which allows a much faster solving time. The dynamics of the robot are considered in a force-based feedback controller for real-time motion planning and control. The optimal pose is then used in combination with a balance controller using QP-based force control to maintain balance and desired pitch angle. Pose optimization also happens to resonate with a crawling mode. In the crawling mode, due to only few critical poses being needed, the computation intensity is dramatically scaled-down compared to full trajectory optimizations. Unlike an approach which adapts a posture of a wheel-legged robot in rough terrain with feedback control, or an approach which adds passive suspension for pose adapting, the example method of finding the optimal poses or robot configurations herein is based on the terrain map.

In this way, the methods and systems described herein introduce a new rigid body dynamics with wheels dynamics that can be effectively used for force-based balancing control of wheel-legged robots. The pose optimization method with kinematic and collision-free constraints only requires solving a few critical poses in a task that consists of high obstacles, while maintaining wheel traction with the terrain. For example, only two poses are needed to solve in a single-stair task. The pose optimization is thus very efficient due to its small problem size. The solved optimal poses at a certain location can be linearly interpolated to obtain the joint trajectory at any given time during the task. Further, a hybrid control framework is utilized that includes force-based QP and joint proportional derivative (PD) control to track optimal poses in order to achieve stable locomotion of wheel-legged robots navigating terrain with high obstacles. Experimental validation based on a real robot demonstrates the capability of rolling up on a 0.36 m obstacle. The experimental robot also successfully rolled up and down multiple stairs without lifting its legs or colliding with the terrain.

One disclosed example is a method for operating a wheel-legged robot. One or more of a desired thigh joint torque for a thigh of a leg of the wheel-legged robot and a desired calf joint torque for a calf of the wheel leg of the wheel-legged robot is determined by a balance controller. The thigh is coupled to the calf via the calf joint. A desired wheel torque for a wheel of the wheel leg of the wheel-legged robot is determined by a rolling controller based on one or more of a wheel traction and yaw. The wheel is coupled to the calf via a wheel joint. One or more of a calf motor, a thigh motor, and a wheel motor of the wheel leg are operated according to the desired thigh joint torque, the desired calf joint torque, and the desired wheel torque.

Another disclosed example is a wheel-legged robot with a set of wheel legs. Each wheel leg includes a thigh actuator rotating a thigh link, a calf actuator rotating a calf link coupled to the thigh link, and a wheel actuator rotating a wheel coupled to the calf link. An input accepts a command for the wheel-legged robot to traverse. A balancing controller is coupled to each of the wheel legs and coupled to the input. The balancing controller determines a desired thigh joint torque for each thigh link and a desired calf joint torque and operating the calf actuators and thigh actuators according to the desired torques. A rolling controller is coupled to each of the wheel legs and the input. The rolling controller determines a desired wheel torque for each wheel based on one or more of a wheel traction and yaw and operates the wheel actuators according to the desired wheel torque.

Another disclosed example is a control system for a wheel-legged robot having wheel-legs. Each of the wheel-legs include a thigh link, a thigh actuator, a calf link, a calf actuator, a wheel, and a wheel actuator. The control system includes an input controller accepting a command for traversing the robot. The input controller outputs a desired position and velocity of the robot. A balancing controller is coupled to the output of the input controller. The balancing controller determines a desired thigh joint torque for each of the thigh links and a desired calf joint torque for each of the calf links. A rolling controller is coupled to the input controller to determine a desired wheel torque for each of the wheels based on one or more of a wheel traction and yaw. A drive controller operates the calf actuator, thigh actuator and wheel actuator according to the desired thigh joint torque, the desired calf joint torque, and the desired wheel torque.

Another disclosed example is a non-transitory, machine readable medium having stored thereon instructions for controlled a wheel-legged robot. The stored instructions comprise machine executable code, which when executed by at least one machine processor, causes the machine processor to determine one or more of a desired thigh joint torque for a thigh of a leg of the wheel-legged robot and a desired calf joint torque for a calf of the wheel leg of the wheel-legged robot, the thigh coupled to the calf via the calf joint. The code causes the machine processor to determine a desired wheel torque for a wheel of the wheel leg of the wheel-legged robot based on one or more of a wheel traction and yaw, the wheel coupled to the calf via a wheel joint. The code causes the machine processor to operate one or more a calf actuator, a thigh actuator, and a wheel actuator of the wheel leg according to the desired thigh joint torque, the desired calf joint torque, and the desired wheel torque.

Another disclosed example is a method of controlling a legged robot to navigate obstacles in a path through a terrain. Terrain of the path is sensed via a terrain sensor. An obstacle from the path is determined from data from the terrain sensor. A series of poses to navigate the obstacle is determined via a pose optimization routine. A pitch angle of the robot, and joint angles of a thigh of a leg of the robot and a calf of the leg of the robot are output by the routine. One or more of a desired thigh joint torque for the thigh and one more of a desired calf joint torque from the pitch angle and joint angles are determined via a tracking controller. A calf actuator and a thigh actuator of the leg are operated according to the desired thigh joint torque and the desired calf joint torque.

Another disclosed example is a robot having a set of legs. Each of the legs includes a thigh link actuated by the thigh actuator, a calf actuator, and a calf link actuated by the calf actuator. The robot includes a terrain sensor and a pose optimization controller coupled to the terrain sensor. The pose optimization controller determines at least one pose to traverse an obstacle in the terrain and outputs a pitch angle and joint angles for the thigh links and calf links. A tracking controller accepts a desired joint angle for the thigh links and calf links and outputs torques for the thigh and calf actuators. A driver controller controls the actuators to position the thigh links and calf links according to the output torques.

Another disclosed example is a non-transitory, machine readable medium having stored thereon instructions for controlling a robot. The stored instructions comprise machine executable code, which when executed by at least one machine processor, causes the machine processor to sense terrain of the path via a terrain sensor. The code causes the machine processor to determine an obstacle from the path from data from the terrain sensor and determine via a pose optimization routine a series of poses to navigate the obstacle. The pose optimization routine outputs a pitch angle of the robot, and joint angles of a thigh of a leg of the robot and a calf of the leg of the robot. The code causes the machine processor to determine one or more of a desired thigh joint torque for the thigh and one more of a desired calf joint torque from the pitch angle and joint angles. The code causes the machine processor to operate a calf actuator and a thigh actuator of the leg according to the desired thigh joint torque and the desired calf joint torque.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1A shows a side view of an example wheel-legged robot rolling up an obstacle, according to an embodiment of the disclosure;

FIG. 1B shows a perspective view of the example wheel-legged robot in FIG. 1A, according to an embodiment of the disclosure;

FIG. 2 shows an example wheel-legged leg of the example robot in FIG. 1A, according to an embodiment of the disclosure;

FIG. 3 shows a block diagram of a robotics system for the example robot in FIG. 1A, according to an embodiment of the disclosure;

FIG. 4 shows a block diagram of an example hybrid control based architecture, according to an embodiment of the disclosure;

FIG. 5 shows a flow chart illustrating an example method for operating a wheel-legged robot, according to an embodiment of the disclosure;

FIG. 6A is a diagram of the example wheel dynamics of the robot leg in FIG. 2, according to an embodiment of the disclosure;

FIG. 6B is a diagram of the example 2D simplified rigid body dynamics with the wheel in the robot leg in FIG. 1A, according to an embodiment of the disclosure;

FIG. 7A shows a series of pose optimization results determined for a single stair task;

FIG. 7B show a series of pose optimization results determined for a multiple-stair task;

FIG. 8A shows a series of experiment snapshots of rolling an example wheel-legged robot over a ramp with the pose optimization, according to an embodiment of the disclosure;

FIG. 8B shows a series of experiment snapshots of rolling an example wheel-legged robot over a ramp without the pose optimization;

FIG. 9A shows a series of example hardware experiment snapshots for the example robot driving up a single step, according to an embodiment of the disclosure;

FIG. 9B shows a series of example hardware experiment snapshots for the example robot driving up three consecutive stairs, according to an embodiment of the disclosure;

FIG. 10 shows joint angle and pitch angle tracking plots in an experimental single-stair obstacle task with pose optimization;

FIG. 11 shows example operations of an example wheel-legged robot in different terrains, according to an embodiment of the disclosure;

FIG. 12A shows a front perspective view of another example robot with two wheel-legs, according to an embodiment of the disclosure;

FIG. 12B shows a back perspective view of the example robot with two wheel-legs in FIG. 12A, according to an embodiment of the disclosure;

FIG. 12C is a front view of the example robot with two wheel-legs in FIG. 12A, according to an embodiment of the disclosure;

FIG. 12D is a rear view of the example robot with two wheel-legs in FIG. 12A, according to an embodiment of the disclosure; and

FIG. 12E is a close up perspective view of the drive assembly for the example robot with two wheel-legs in FIG. 12A, according to an embodiment of the disclosure.

### DETAILED DESCRIPTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described.

In some embodiments, properties such as dimensions, shapes, relative positions, and so forth, used to describe and claim certain embodiments of the invention are to be understood as being modified by the term “about.”

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The present disclosure is directed toward an example dynamic wheel-legged robot that is capable of extreme terrain mobility. The example dynamic wheel-legged robot includes both wheels and legs that can leverage the advantages from both leg based robots and wheel based robots. The example dynamic wheel-legged robot enables maneuverability, high energy efficiency, and high speed on rough terrain. As an example, the ROLLER1 (ROLing-with-LEgs Robot V1) that incorporates the principles herein can overcome a wide variety of extreme terrains using different functionalities. The example ROLLER1 robot can combine walking and rolling on rocky terrain, rolling while crawling to go through a small opening, rolling on a steep slope or jumping through a large gap.

Due to their morphology, legged robots have a unique capability to navigate rough terrain. However, while legged robots have advantages in navigating uneven terrain, they are not reliable at achieving high speeds and not energy efficient in traveling for long distances. Wheeled robots, in contrast, are generally much more energy efficient and capable of faster speeds on an even surface or flat ground. However, robots with only wheels have a very limited capability in navigating rough terrains. Therefore, methods and systems are provided herein for operating and/or controlling a highly dynamic wheel-legged quadrupedal robot. The wheel-legged robot is a hybrid system of both wheels and legs that leverages the advantages from both leg based robots and wheel based robots. The wheel-legged robot described herein may run and jump over extreme terrain at high speed with high energy efficiency.

With the capability of navigating rough terrain with high speed and high energy efficiency, the methods and systems described herein may be useful for applications such as last-mile delivery, space exploration, search and rescue, firefighting, inspection in construction, mining, and nuclear plant operation. Currently, mostly wheeled vehicles are used for space exploration and last-mile delivery. However, such solutions are limited as they cannot access places that require rough terrain navigation. Legged robots are expanding their roles in disaster response and the construction industry due to the complexity of the terrains in those scenarios. Nevertheless, slow navigation speeds and short operation times are disadvantages that limit the performance of legged robots in these applications. Thus, the wheel-legged robots described herein can effectively address these shortcomings while offering an improved capability of navigating rough terrain.

For example, the example wheel-legged robotic system may be used in off-world extreme lunar terrain applications. Compared to the traditional wheeled mobility systems, the example wheel-legged robot has the capability of traversing into deep, shadowed craters to search for resources. Further, the example wheel-legged robot can travel up steep slopes with rocky terrains to place communications or power generation systems. In addition, the example wheel-legged robot can travel deep into subterranean features or high porosity surfaces in search of lunar volatiles and surface samples.

Besides the space industry, the example wheel-legged robot may be used to navigate to and through difficult to access locations such as remote or rural areas. By controlling the ground reaction forces of all four legs, the example wheel-legged robot is also extremely effective in traversing slippery terrains such as snow.

Further, in various implementations, the wheel-legged robot is capable of utilizing different locomotion modes such as rolling, simultaneous walking-rolling, and pure walking modes to maximize mobility in various challenging terrains such as mud, grass, sand, and even snow.

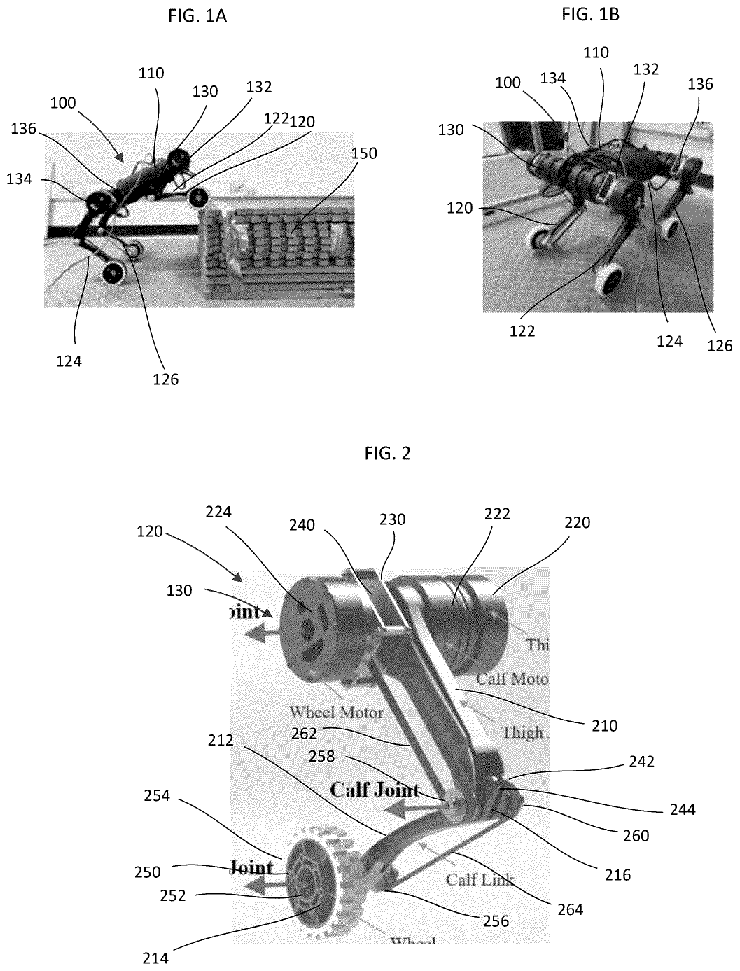

FIG. 1A shows a side view of an example wheel-legged robot 100 rolling up to an obstacle 150. In this example, the obstacle 150 is taller than the robot 100 and requires the example control framework using pose optimization to traverse. FIG. 1B shows a perspective view of the example wheel-legged robot 100. The robot 100 may also be referred to as a robot, robotic device, or mobile robot, among other designations. The wheel-legged robot 100 includes a robot trunk enclosure 110, and four sets of 3 degrees of freedom (DoF) legs 120, 122, 124 and 126. The legs 120, 122, 124 and 126 are arranged in a quadruped with a front right leg 120, a front left leg 122, a back right leg 124 and a back left leg 126. Each leg 120, 122, 124 and 126 includes a thigh, a calf, and a wheel that are all actuated by different groups of respective actuator assemblies 130, 132, 134, and 136 controlled by the robot control system. In total, the example wheel-legged robot 100 has 12 actuators for the four legs 120, 122, 124 and 126. The wheel actuators assemblies 130, 132, 134, and 136 are strategically positioned near the trunk enclosure 110. This allows delivery of power to the wheels via a two-stage timing belt system, rather than being directly mounted onto the wheel. This design minimizes inertia on the legs 120, 122, 124 and 126, enabling enhanced precision in force-based control.

The trunk enclosure 110 encloses components such as a power supply, a control system, a transceiver, payload, and sensor support components. As will be explained, the control system allows the robot 100 to traverse uneven terrain with large obstacles such as the obstacle 150.

FIG. 2 shows an example leg assembly and joints of a wheeled leg with three degrees of freedom such as the leg 120 in FIG. 1A. The example leg 120 includes a thigh link 210, a calf link 212, and a wheel 214. The thigh link 210 is rotatably coupled to a calf joint 216. One end of the calf link 212 thus may be rotated on the calf joint 216. An opposite end of the calf link 212 is coupled to the wheel 214. The leg 120 is actuated by a thigh actuator 220, a calf actuator 222, and a wheel actuator 224. In this example, the actuators 220, 222, and 224 are torque-controller AI motors that can provide 21.0 rad/s maximum angular speed and 33.5 Nm maximum torque output that are available from Unitree. Other types of actuators with different angular speeds and torques may be used.

In this example, the actuator assembly 130 includes a transmission box 230 that supports the actuators 220, 222 and 224. One end 240 of the thigh link 210 opposite the calf joint 216 is rotatably supported by the transmission box 230. The thigh link 210 may thus be rotated by the actuator 220. An opposite end 242 of the thigh link 210 supports a pin that allows the rotation of the calf link 212 around the calf joint 216. The calf link 212 includes a linkage 244 that is rotatably attached to the calf actuator 222 and rotates the calf link 212 around the calf joint 216. In this example, the leg mounting components for the actuators and transmission assemblies are achieved by using laser-cut parts. This design is thus low-cost and light-weight allowing energy savings for the actuators. The light-weight parts also reduces unwanted dynamic effect of the legs in the system and lowers motor torque limit requirements during balancing control and navigating high obstacles.

The end of the calf link 212 coupled to the wheel 214 includes an axle 250 that has one end that supports a hub 252. The exterior surface of the hub 252 includes a set of treads 254 that contact the terrain surface. The opposite end of the axle 250 is attached to a pulley wheel 256. The calf joint 216 includes a translational pulley wheel 258 that is mounted on opposite ends of an axle from a main pulley wheel 260. The main pulley wheel 260 is rotated by an upper wheel drive belt 262 that is rotated by a drive wheel supported by the transmission box 230. The drive wheel is rotationally powered by the wheel actuator 224 to rotate the upper wheel belt 262. The rotation of the upper wheel drive belt 262 rotates the main pulley wheel 260 and thus the translational pulley wheel 258. A lower wheel drive belt 264 that is proximate the calf link 212 rotates the pulley wheel 256 that in turn rotates the wheel hub 252.

In this example, the mass (m) of the example robot 100 is 11.84 kg, the body inertia in the x dimension (Iₓₓ) is 0.0214 kg·m², the body inertia in the y dimension (I_{yy}) is 0.0535 kg·m², and the body inertia in the z dimension (I_{zz}) is 0.0443 kg·m². The body length (I_{b}) is 0.247 m, the body width (w_{b}) is 0.194 m, and the body height (h_{b}) is 0.114 m. The thigh length (I₁) is 0.2 m and the calf length (I₂) is 0.2 m. The wheel radius (R_{wheel}) is 0.05 m. It is to be understood that the example dimensions may be modified for larger or smaller robots with different mass, and corresponding thigh and calf lengths and wheel radius.

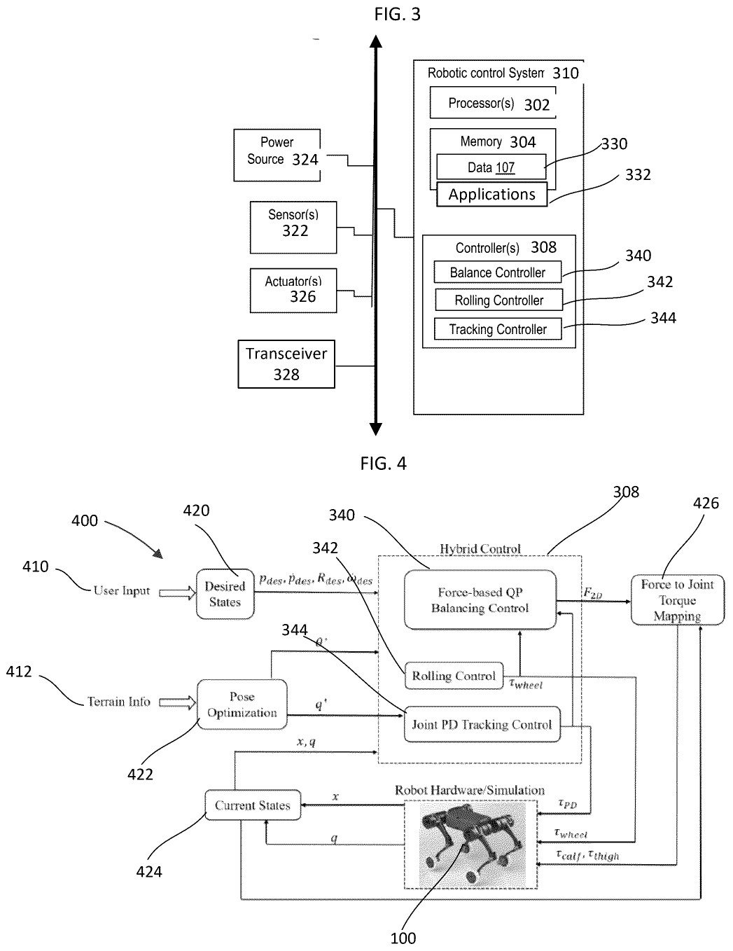

A block diagram of an example robotic system 300 that may be used in connection with the implementations described herein of the example robot 100 is shown at FIG. 3. Referring to FIG. 3, the robotic system 300 may be configured to operate autonomously, semi-autonomously, and/or using directions provided by user(s). The robotic system 300 may be implemented in various forms, such as a wheel-legged robot which may be a biped robot, quadruped robot, such as the robot 100, or some other arrangement.

As shown, the robotic system 300 may include processor(s) 302, data storage 304, and controller(s) 308, which together may be part of a control system 310. The robotic system 300 may also include sensor(s) 322, power source(s) 324, actuators 326, and transceiver(s) 328. In this example, the actuators 326 represent the actuator assemblies 130, 132, 134, and 136 in FIGS. 1A-1B. The robotic system 300 may further include mechanical components and/or electrical components. Nonetheless, the robotic system 300 is shown for illustrative purposes, and may include more or fewer components. The various components of robotic system 300 may be connected in any manner, including wired or wireless connections. Further, in some examples, components of the robotic system 300 may be distributed among multiple physical entities rather than a single physical entity. Other example illustrations of robotic system 300 may exist as well.

Processor(s) 302 may operate as one or more general-purpose hardware processors or special purpose hardware processors (e.g., digital signal processors, application specific integrated circuits, etc.). The processor(s) 302 may be configured to execute computer-readable program instructions 330, and manipulate data 332, both of which are stored in the data storage 304. The processor(s) 302 may also directly or indirectly interact with other components of the robotic system 300, such as sensor(s) 322, power source(s) 324, actuators 326, transceiver 328, mechanical components, and/or electrical components. The transceiver 328 may be used to communicate data or command signals with an external device.

The data storage 304 may be one or more types of hardware memory. For example, the data storage 304 may include or take the form of one or more computer-readable storage media that can be read or accessed by processor(s) 302. The one or more computer-readable storage media can include volatile and/or non-volatile storage components, such as optical, magnetic, organic, or another type of memory or storage, which can be integrated in whole or in part with processor(s) 302. In some implementations, the data storage 304 can be a single physical device. In other implementations, the data storage 304 can be implemented using two or more physical devices, which may communicate with one another via wired or wireless communication. As noted previously, the data storage 304 may include the computer-readable program instructions 330 and the data 332. The data 332 may be any type of data, such as configuration data, sensor data, and/or diagnostic data, among other possibilities.

The controller 308 may include one or more electrical circuits, units of digital logic, computer chips, and/or microprocessors that are configured to (perhaps among other tasks), interface between any combination of the mechanical components, the sensor(s) 322, the power source(s) 324, the electrical components, the control system 310, and/or a user of the robotic system 300. In some implementations, the controller 308 may be a purpose-built embedded device for performing specific operations with one or more subsystems of the robotic device 100.

The controller 308 may monitor and physically change the operating conditions of the robotic system 300. In doing so, the controller 308 may serve as a link between portions of the robotic system 300, such as between mechanical components and/or electrical components. In some instances, the controller 308 may serve as an interface between the robotic system 300 and another computing device. Further, the controller 308 may serve as an interface between the robotic system 300 and a user. The instance, the controller 308 may include various components for communicating with the robotic system 300, including a joystick, buttons, and/or ports, etc. The example interfaces and communications noted above may be implemented via a wired or wireless connection, or both. The controller 308 may perform other operations for the robotic system 300 as well.

During operation, the controller 308 may communicate with other systems of the robotic system 300 via wired or wireless connections, and may further be configured to communicate with one or more users of the robot 100. As one possible illustration, the controller 308 may receive an input (e.g., from a user or from another robot) through the transceiver 328 indicating an instruction to perform a particular gait in a particular direction, and at a particular speed. A gait is a pattern of movement of the limbs of an animal, robot, or other mechanical structure.

Based on this input, the controller 308 may perform operations to cause the robotic device 100 to move according to the requested gait. As another illustration, the controller 308 may receive an input indicating an instruction to move to a particular geographical location. In response, the controller 308 (perhaps with the assistance of other components or systems) may determine a direction, speed, and/or gait based on the environment through which the robotic system 300 is moving en route to the geographical location. In this example, the controller 308 includes a specific balance controller 340, a rolling controller 342 and a tracking controller 344 for performing hybrid control of the robotic system 300.

The balance controller 340 is a quadratic programming (QP) force-based balance controller that maintains balance in various tasks. The example QP control algorithm may be solved very efficiently, and thus may be applied to real-time control of a wheel-legged robot such as the robot 100. This balancing control only commands the thigh and calf joint torques of the wheel legs of the robot 100. For controlling the wheels, the rolling controller 342 enables the robot 100 to maneuver with wheel traction and yaw on command. The details of the balancing control will be explained below. The controller 308 also collects real-time data relating to the joint angles of calf links and the thigh links of the legs. In order to control the robot 100 to roll over challenging terrains (e.g., stairs, high obstacles, or steep ramps), a pose optimization framework is used to solve for an optimal configuration of the robot 100 that is collision-free with the terrain, while maintaining a good support region for the robot to keep the body balanced. The desired pitch angle is fed into the balance controller 340 to maintain balance during motion of the robot 100. The desired joint angles of the calf links of the wheeled legs are tracked by the tracking controller 344 to output a joint proportional derivative (PD) torque to control the calf actuators to manipulate the pose of the robot.

Operations of the control system 310 may be carried out by the processor(s) 302.

Alternatively, these operations may be carried out by the controller 308, or a combination of the processor(s) 302 and the controller 308. In some implementations, the control system 310 may partially or wholly reside on a device other than the robotic system 300, and therefore may at least in part control the robotic system 300 remotely.

Mechanical components represent hardware of the robotic system 300 that may enable the robot 100 to perform physical operations. As a few examples, the robotic system 300 may include physical members such as wheeled legs, leg(s), arm(s), and/or wheel(s). The physical members or other parts of robotic system 300 may further include actuators such as motors arranged to move the physical members in relation to one another. The robotic system 300 may also include one or more structured bodies for housing the control system 310 and/or other components, and may further include other types of mechanical components. The particular mechanical components used in a given robot may vary based on the design of the robot, and may also be based on the operations and/or tasks the robot may be configured to perform.

In some examples, the mechanical components may include one or more removable components. The robotic system 300 may be configured to add and/or remove such removable components, which may involve assistance from a user and/or another robot. For example, the robotic system 300 may be configured with removable arms, hands, feet, and/or legs, so that these appendages can be replaced or changed as needed or desired. In some implementations, the robotic system 300 may include one or more removable and/or replaceable battery units or sensors. Other types of removable components may be included within some implementations.

The robotic system 300 may include sensor(s) 322 arranged to sense aspects of the robotic system 300. The sensor(s) 322 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, and/or cameras, among other possibilities. Within some examples, the robotic system 300 may be configured to receive sensor data from sensors that are physically separated from the robot (e.g., sensors that are positioned on other robots or located within the environment in which the robot is operating).

The sensor(s) 322 may provide sensor data to the processor(s) 302 (perhaps by way of data 332) to allow for interaction of the robotic system 300 with its environment (e.g., surrounding terrain), as well as monitoring of the operation of the robotic system 300. The sensor data may be used in evaluation of various factors for activation, movement, and deactivation of mechanical components and electrical components by control system 310. For example, the sensor(s) 322 may capture data corresponding to the terrain of the environment or location of nearby objects, which may assist with environment recognition and navigation. In an example configuration, sensor(s) 322 may include RADAR (e.g., for long-range object detection, distance determination, and/or speed determination), LIDAR (e.g., for short-range object detection, distance determination, and/or speed determination), SONAR (e.g., for underwater object detection, distance determination, and/or speed determination), VICON® (e.g., for motion capture), one or more cameras (e.g., stereoscopic cameras for 3D vision), a global positioning system (GPS) transceiver, and/or other sensors for capturing information of the environment in which the robotic system 300 is operating. The sensor(s) 322 may monitor the environment in real time, and detect obstacles, elements of the terrain, weather conditions, temperature, and/or other aspects of the environment.

Further, the robotic system 300 may include sensor(s) 322 configured to receive information indicative of the state of the robotic system 300, including sensor(s) 322 that may monitor the state of the various components of the robotic system 300. The sensor(s) 322 may measure activity of systems of the robotic system 300 and receive information based on the operation of the various features of the robotic system 300, such the operation of extendable legs, arms, or other mechanical and/or electrical features of the robotic system 300. The data provided by the sensor(s) 322 may enable the control system 310 to determine errors in operation as well as monitor overall operation of components of the robotic system 300.

As an example, the robotic system 300 may use force sensors to measure load on various components of the robotic system 300. In some implementations, the robotic system 300 may include one or more force sensors on an arm or a leg to measure the load on the actuators that move one or more members of the arm or leg. As another example, the robotic system 300 may use one or more position sensors to sense the position of the actuators of the robotic system and thus the joint angles of wheeled legs. For instance, such position sensors may sense states of extension, retraction, or rotation of the actuators on arms or legs.

As another example, the sensor(s) 322 may include one or more velocity and/or acceleration sensors. For instance, the sensor(s) 322 may include an inertial measurement unit (IMU). The IMU may sense velocity and acceleration in the world frame, with respect to the gravity vector. The velocity and acceleration sensed by the IMU may then be translated to that of the robotic system 300 based on the location of the IMU in the robotic system 300 and the kinematics of the robotic system 300.

The robotic system 300 may include other types of sensors not explicated discussed herein. Additionally or alternatively, the robotic system may use particular sensors for purposes not enumerated herein.

The robotic system 300 may also include one or more power source(s) 324 configured to supply power to various components of the robotic system 300. Among other possible power systems, the robotic system 300 may include a hydraulic system, electrical system, batteries, and/or other types of power systems. As an example illustration, the robotic system 300 may include one or more batteries configured to provide charge to components of the robotic system 300. Some of the mechanical components and/or electrical components may each connect to a different power source, may be powered by the same power source, or be powered by multiple power sources.

Any type of power source may be used to power the robotic system 300, such as electrical power or a gasoline engine. Additionally or alternatively, the robotic system 300 may include a hydraulic system configured to provide power to the mechanical components using fluid power. Components of the robotic system 300 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of the robotic system 300. The power source(s) 324 may charge using various types of charging, such as wired connections to an outside power source, wireless charging, combustion, or other examples.

The electrical components may include various mechanisms capable of processing, transferring, and/or providing electrical charge or electric signals. Among possible examples, the electrical components may include electrical wires, circuitry, and/or wireless communication transmitters and receivers to enable operations of the robotic system 300. The electrical components may interwork with the mechanical components to enable the robotic system 300 to perform various operations. The electrical components may be configured to provide power from the power source(s) 324 to the various mechanical components, for example. Further, the robotic system 300 may include electric motors. Other examples of electrical components may exist as well.

Although not shown in FIG. 3, the robotic system 300 may include a body, which may connected to or house appendages and components of the robotic system such as the trunk enclosure 110 in FIG. 1A. As such, the structure of the body may vary within examples and may further depend on particular operations that a given robot may have been designed to perform. For example, a robot developed to carry heavy loads may have a wide body that enables placement of the load. Similarly, a robot designed to reach high speeds may have a narrow, small body that does not have substantial weight. Further, the body and/or the other components may be developed using various types of materials, such as metals or plastics. Within other examples, a robot may have a body with a different structure or made of various types of materials.

The body and/or the other components may include or carry the sensor(s) 322. These sensors 322 may be positioned in various locations on the robotic device 100, such as on the body and/or on one or more of the appendages, among other examples.

On its body, the robotic device 100 may carry a load, such as a type of cargo that is to be transported. The load may also represent external batteries or other types of power sources (e.g., solar panels) that the robotic device 100 may utilize. Carrying the load represents one example use for which the robotic device 100 may be configured, but the robotic device 100 may be configured to perform other operations as well.

As noted above, the robotic system 300 may include various types of legs, arms, wheels, and so on. In some examples, the robotic system 300 may be configured with one or more legs. In some examples, an implementation of the robotic system with one or more legs may additionally include wheels, treads, or some other form of locomotion. An implementation of the robotic system with two legs may be referred to as a biped, and an implementation with four legs may be referred as a quadruped. Implementations with six or eight or 10 or more legs are also possible.

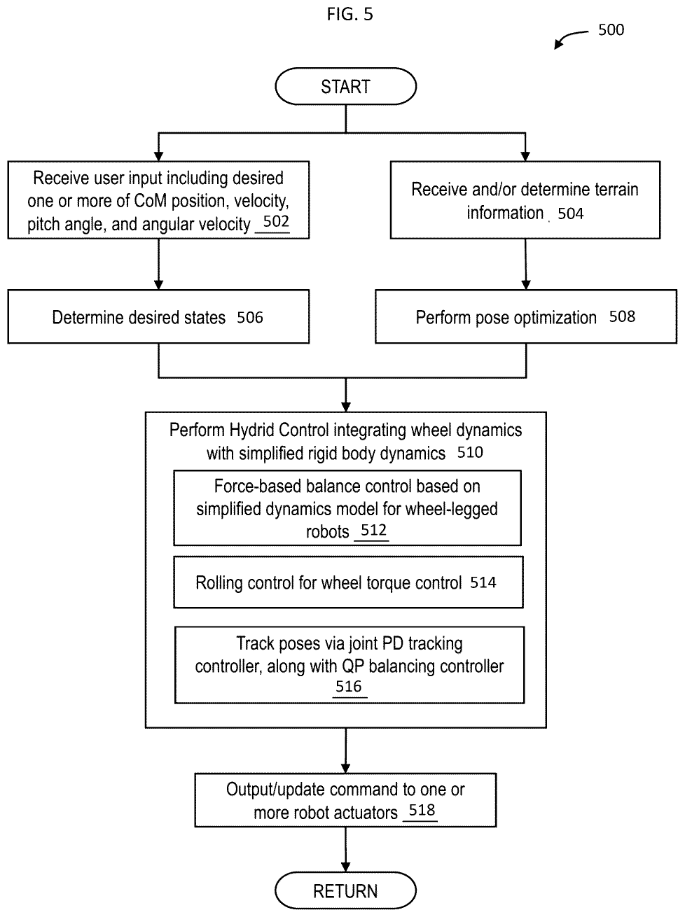

The block diagram of an example control architecture 400 executed by the processor 302 and control system 310 is shown in FIG. 4. The control architecture 400 is centered around the quadratic programming (QP) force-based balance controller 340 that maintains balance in various tasks and the rolling controller 342 enables the robot to maneuver with wheel traction and yaw on command. A tracking controller 344 collects pose optimization data on desired joint angles, The pose optimization is generated from terrain sensors 322 that provide data relating to obstacles in the terrain. The tracking controller 344 then outputs a proportional derivative joint torque from the input joint angles.

The architecture 400 reacts to a user input 410 and a terrain input 412. The user input 410 may be commands input by a human operating a control device (e.g., via joystick, steering wheel, and the like), or a controller that is programmed to steer the robot on a route, or an autonomous AI controller. The terrain input 412 collects terrain sensing data collected by terrain sensors such as some of the sensors 322 in FIG. 3.

The user input 410 is translated into a set of desired states via a desired states routine 420 that may be executed by a suitable controller or processor. In this example, the set of desired states output by the desired states routine 420 includes center of mass (CoM) position, velocity, yaw, roll, pitch angle θ_{des} and angular velocity of the robot. The roll, pitch and yaw desired states are determined by the control device. Alternatively, the roll, pitch and yaw desired states may be preset from a control program. Data from the terrain input 412 is input into a pose optimization states routine 422. The dimensions of any obstacles in the terrain data are input into pose optimization state routine 422, which determines optimal poses to traverse such terrain obstacles. The pose optimization state routine 422 is executed by a suitable controller or processor. The pose optimization state routine may thus change desired pitch information based on the results of the pose optimization. Thus, the pose optimization state routine 422 provides the body pitch angle θ and desired limb joint angles, q of each of the legs. The set of desired states output by the desired state routine 420 feeds the CoM position, velocity, pitch angle, θ_{des} and angular velocity as inputs into the controller 308. When irregular terrain or obstacles are sensed, the pose optimization state routine 422 feeds a body pitch angle θ and a set of limb joint angles, q, for an optimal pose to navigate the obstacle into the controller 308. The limb joint angle data, q, is specifically fed into the tracking controller 344. A current state 424 feeds the current location position, x, and limb joint angle data, q, to the controller 308. The rolling controller 342 outputs a desired wheel torque to the balance controller 340. The tracking controller 344 outputs joint proportional derivative (PD) torque to the balance controller 340 based on data from a pose optimization routine.

The balance controller 340 outputs the x and z forces on the legs (F_{2D}) to a force to torque mapping module 426. The position data, x, and limb joint angle data, q, from the current state 424 is also fed into the force to torque mapping module 426. The force to torque mapping module 426, which may be part of a drive controller executed by the control system 100, outputs the desired torques of the calf joints and thigh joints to the appropriate actuators on the robot 100. Alternatively, the robot 100 may be replaced with a hardware simulator for testing purposes. The rolling controller 342 outputs the desired wheel torque to the robot 100. A position sensor on the robot 100 outputs a position output, x, and a set of current joint angle data, q, to the current state 424.

An example routine for operating a wheel-legged robot is shown at FIG. 5. FIG. 5 is a flow chart depicting a high-level routine 500 for controlling a navigation of a wheel legged robot over terrain. The flow diagram in FIG. 5 is representative of example machine readable instructions for controlling navigation of a robot over terrain. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 5 may be implemented manually. Further, although the example algorithm is described with reference to the flowchart illustrated in FIG. 5, persons of ordinary skill in the art will readily appreciate that many other methods of implementing the example machine readable instructions may alternatively be used. For example, the order of execution of the blocks may be changed, and/or some of the blocks described may be changed, eliminated, or combined.

In this example, the routine 500 may be implemented by one or more controllers of the control system 310, such as a balancing controller 320 for force-based balance and adjusting thigh and calf torques, the rolling controller 342 for controlling wheel torque, the tracking controller 344 for assisting in balancing the robot while the robot is rolling over one or more obstacles. The routine 500 comprises receiving user input regarding desired states, obtaining terrain information, and performing hybrid control of balance and rolling along with real-time tracking control to command the robot actuators to perform one or more tasks as shown in FIG. 4.

The routine 500 first receives user input 410 that is input to the desired states routine 422 that outputs data including a desired CoM position, velocity, pitch angle, yaw, roll, and angular velocity for the positioning of the robot (502). The routine also receives data and/or determines terrain information from the raw collected data (504). The routine then determines the desired states based on the user input (506). The routine 500 also performs pose optimization based on the terrain information and outputs optimal poses to navigate obstacles (508).

The routine then performs hybrid control determination that integrates wheel dynamics with simplified rigid body dynamics (510). The determination (510) includes force-based balance control based on a simplified dynamics model for wheel legged robots (512) performed by the balance controller 340. The determination also includes rolling control for wheel torque control determined by the rolling controller 342 (514). The determination also includes track poses via joint proportional derivative (PD) tracking data determined by the tracking controller 344 in conjunction with the balancing controller 340. The routine then outputs an updated command to the actuators of the legs to move the robot (518).

A simplified dynamics model for wheel-legged robots can be used effectively in real-time feedback control for balancing the robot body via the control architecture 400 in FIG. 4. Single rigid-body dynamics are commonly used for controlling quadruped robots. However, when the example robot 100 highly leverages the wheels of the legs in traversing uneven terrain, it is critical to take into account the impact of wheel traction forces on the robot dynamics. In this example, the simplified dynamics model takes wheel dynamics into consideration. The control framework has been divided into balancing control and rolling control. The output of the balancing controller 340 is mapped to only the thigh and calf torques of each of the legs, while the wheel torque of the wheels of the legs is controlled by the rolling controller 342. The two decoupled control methods are connected by combining the wheel dynamics with the simplified rigid body dynamics of the quadruped robot to become a hybrid linear dynamics model. The output of the two combined methods may be used in the QP balancing controller 340.

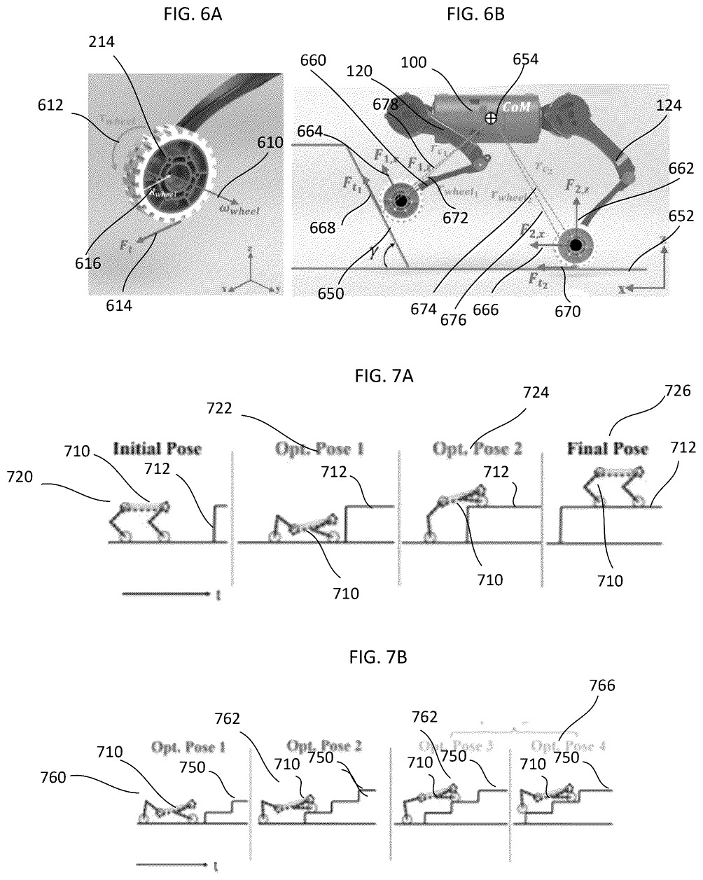

FIG. 6A shows the wheel dynamics of an example wheel 214 of the robot 100. FIG. 6B shows the simplified rigid body dynamics of the robot 100. In relation to FIG. 6A, the wheel dynamics in angular motion while on the ground may be expressed as:

$${I}_{wheel} \cdot {\dot{ω}}_{wheel} = {τ}_{wheel} , - {F}_{t} , \cdot {R}_{wheel} , \qquad ( 1 )$$

where I_{wheel} is the rotation inertia of the wheel, \dot{ω}_{wheel} is the angular acceleration of the wheel (expressed as arrow 610), τ_{wheel}, is the wheel torque (expressed as arrow 612) of the i^{th} leg from control input, and F_{t.} is the wheel traction force (expressed as arrow 614) of the i^{th} leg at ground contact point on the rim of the wheel. The radius of the wheel is represented as a line 616 in FIG. 6A. The very small rotation inertia value of the wheel dynamics is neglected to obtain a linear relation of the wheel torque and traction force, equation (1) is then reduced to:

$$\text{?}$$

$$\text{?} \text{indicates text missing or illegible when filed}$$

When the wheel contact point is on an aggressive slope, it is important to take into consideration of the change in coordinate frames of ground reaction forces as well as friction constraints.

FIG. 6B shows the simplified rigid body dynamics in one scenario when the wheels of the front legs 120 and 122 of the robot 100 are on a slope 650 with a positive angle γ. The wheels of back legs 124 and 126 remain on a level terrain 652. For simplification the forces are shown only on the front leg 120 and the back leg 124. A center of mass (CoM) 654 is shown for the robot 100. The ground reaction force in the z-direction (shown by arrows 660 and 662) has to be normal to the terrain while the ground reaction force in the x-direction (shown by arrows 664 and 666) has to be parallel to the terrain.

The simplified dynamics of the robot can be written as:

$$\text{?}$$

$$\text{?} \text{indicates text missing or illegible when filed}$$

The term F is a force vector containing 2D ground reaction forces at the center of each wheel, F=[F_{1,x}, F_{1,z}, . . . F_{4,x}, F_{4,z}]^{T} represented by the arrows 660 and 662 for force on legs 120 and 124 in the x direction and arrows 664 and 666 for force on legs 120 and 124 in the z direction. Similarly, F_{wheel} is a column vector containing the wheel traction forces obtained from equation (2), F_{wheel}=[Fₜ₁, 0, . . . Fₜ₄, 0]^{T} represented by arrows 668 and 670 for the wheels of the legs 120 and 124. The wheels of the legs 120 and 124 only contribute force in the direction of the ground.

In equation (4) and (5), r_{ci} is the vector of distance from the trunk CoM 654 (represented by lines 672 and 674 for legs 120 and 124) to the center of the ith wheel and r_{wheeli} is the distance from the CoM 654 to the ground contact point of the i^{th} wheel, i=1, . . . , 4, r_{ci}×=[r_{ci,z},−r_{ci,x}], and r_{wheeli}×=[r_{wheeli,z}−r_{wheeli,x}]. In equation (6), p_{c} is the linear acceleration of the robot CoM in 2D (x and z-direction), g is the gravity vector in 2D, I_{w} is the rotation inertia of the robot body in the world frame, and ω^{·} is the angular acceleration of the robot body around y-axis. Similarly, if the rear wheels are in contact with a sloped surface, the formulation in equations (4) and (5) may be modified to reflect the change of frames of the corresponding ground reaction forces.

Since the dynamics model in equation 3 is linear, the dynamics constraints can be incorporated in a quadratic program (QP) as follows. This principle may be adopted using the model of rigid body dynamics with wheels for wheel-legged robots. The balancing control employs a PD control policy of the robot body CoM position. The balancing control also makes sure the inequality constraints such as force saturation and friction constraints are stratified in the optimal solution.

In this example, an example controller tends to drive the robot dynamics to the following desired dynamics that follows a PD control law:

$$\text{?}$$

$$\text{?} \text{indicates text missing or illegible when filed}$$

The right-hand side of equation (8) contains user input command in terms of desired CoM position, velocity, pitch angle θ_{des} and angular velocity. The left-hand side can then be used to represent the desired b matrix in the dynamics equation (3):

$$\text{?}$$

$$\text{?} \text{indicates text missing or illegible when filed}$$

Then, the desired dynamics may be obtained by driving the left-hand side of the dynamics equation (3) to:

$${A}_{c} \cdot F \to {b}_{des} - {A}_{wheel} \cdot {F}_{wheel} \qquad ( 10 )$$

where the value of F_{wheel} is dependent on wheel torques. As explained above, the wheel torques (shown as arrows 676 and 678 for the wheels of legs 120 and 124 respectively) are determined by the rolling controller 342. Equation (10) can be obtained by the following quadratic program:

$$\text{?}$$

$$\text{?} \text{indicates text missing or illegible when filed}$$

where, D=A_{c}F+A_{wheel}F_{wheel}−b_{des}. Equation (11) is the cost function of this QP problem. The main goals of the cost function are driving robot CoM location close to the desired command, minimizing the optimal force Fₒₚₜ, and filtering the difference of optimal force at the current time step and previous optimal force F_{opt.prev}. These three tasks are weighted by S, α, and β to determine the task priorities. Equation (12) summarizes the friction cone constraint and saturation of computed ground reaction force.

The resulting optimal force inputs from the QP problem in equations (11) and (12), Fₒₚₜ=[F_{1,x}, F_{1,z}, . . . . F_{4,x}, F_{4,z}]^{T} are then mapped to the thigh and calf joint torques for each leg by:

$${τ}_{QP , i} = {J}_{i}^{T} [ \begin{matrix}{F}_{i , x} \\ {F}_{i , 𝓏}\end{matrix} ] ,$$

Where Jᵢ is the leg Jacobian matrix of ith leg.

While the QP force control provides balance and stability to the wheel-legged robot during motion, the forward velocity and yaw control of the robot can be realized by leveraging the rolling motion of the wheels of the legs 120, 122, 124, and 126. With a given CoM velocity command, the wheel torque is calculated using the following feedback law:

$${τ}_{wheel} = {K}_{d , wheel} ( {\dot{q}}_{wheel , des} - {\dot{q}}_{wheel} ) , \qquad ( 14 )$$

where ^{·}q_{wheel} is the measurement of the wheel joint angular velocity, and

$${\dot{q}}_{wheel , des} = \frac{{\dot{p}}_{{c}_{x} , des}}{{R}_{wheel}} , \qquad ( 15 )$$

with \dot{p}_{cx,des} being the desired forward velocity. On top of this rolling control based on the input linear velocity command, the rolling controller 342 can also track a desired yaw speed command during rolling motion. This is achieved by assigning a difference Δq_{wheel.des} in commanded angular speed to the left and right wheel joints, to achieve a feedback turning control. And Δq_{wheel} is adjusted by a yaw-speed (ψ) controller,

$$Δ {\dot{q}}_{wheel} = {K}_{d , \dot{ψ}} ( {\dot{ψ}}_{des} - \dot{ψ} ) . \qquad ( 16 )$$

The combination of QP force-based balance control and rolling control allows the wheel-legged robot to have stable dynamic locomotion over uneven terrain by taking the advantage of wheel rolling traction.

The architecture of the hybrid control method enables stable locomotion of wheel-legged robots only leveraging the wheel rolling motion. However, with only balancing control and wheel rolling control, the robot 100 is unable to pass more complex terrains such as terrain with a very steep slope and tall staircases, such as examples shown in FIGS. 7A-7B. A pose optimization method based on robot kinematics can solve for optimal poses for a given task that consists of rolling over high obstacles while ensuring collision-free constraints with the terrain. Pose optimization is a motion planning technique that can be used with terrain map information from terrain sensors as input data. The terrain data may be analyzed to determine the type of obstacle. For example, the terrain data may be analyzed to determine parameters such as what kinds of the obstacle are in front or the robot, number of stairs, stair height, stair depth, stair width, ramp height, ramp degrees, or ramp width. The pose optimization routine 422 outputs the desired joint angles and pitch angles for optimal poses to traverse the obstacles. This approach allows the robot to roll over tall obstacles that exceed the nominal height of the robot.

One example task is where the wheel-legged robot needs to climb up a high stair. This task focuses on manipulating the robot to maintain and transform between different poses in order to create a large stability region for better working the QP balance controller while the robot is on a slope and while the body is at a significant pitch angle. In order to decrease the problem computation expense, the pose optimization routine only needs to compute two optimal poses in 2D plane at certain positions in a single-stair obstacle task. The kinematic constraint in the example pose optimization routine uses forward-kinematics (FK) to compute link, wheel, and collision model locations based on the input joint and pitch angle information. With this information, desired constraints may be directly applied to the pose, such as constraining wheels to the terrain, avoiding collisions between the obstacle and the robot, and allowing the pose to have a large stability region. Due to only few critical poses being needed and using a 2D model of the robot for the example pose optimization, the computation intensity is dramatically scaled-down compared to full trajectory optimizations. The example method of finding the optimal poses or robot configurations herein is based on the terrain mapping and thus further eliminates complex inputs that may reduce computational efficiency. Finally, as will be explained, a limited set of collision points on the model are evaluated to further reduce necessary computations.

In particular, FIG. 7A shows the optimized poses determined for a single-stair task, and FIG. 7B shows the optimized poses for a multiple-stair task. In this example, the robot is modeled using sticks representing the links and the body. The collision model is represented in dots in the links that allow collisions with the terrain to be checked in each determined pose. The determination of the pose optimization is performed as a nonlinear programming problem (NLP).

FIG. 7A shows a robot model 710 in relation to a single stair 712 in a series of pose locations 720, 722, 724, and 726. In this example, the robot model 710 has five links (legs and body). In this example, the poses are represented in 2D and pose optimization is determined in 2D as well, for computation efficiency. As shown in FIG. 7A, the two pose locations 722 and 724 have the largest kinematic changes during the transition from ground to the upper surface. These poses 722 and 724 are the optimal poses determined by the pose optimization routine for navigating the single stair 712. The example poses 722 and 724 are determined by the degree of kinematic changes, in this case, before rolling up the stairs and after the front wheels are on the stairs. To ensure these critical poses are collision-free, the collision model of the robot was directed to 25 possible collision points placed across the robot trunk and limbs represented by the dots in the pose locations 720, 722, 724, and 726. The total number of the points is determined by trial-and-error from simulation results and is the middle ground of a well-constrained problem vs. computation time. In this example, five collision points were provided on each link of the 5-link robot model 710. The analysis of the collision points allows the robot pose optimization routine to avoid collisions during performance of the pose optimization. More collision points cause the problem to be more computationally intense and extend the computation time. Fewer collision points may risk experiencing increased collision violations in different poses.

The optimization method also has great potential of extending its usage to more complex terrains such as multiple-stair obstacles. FIG. 7B shows the robot model 700 on a multiple stair obstacle 750. Dots represent collision points in the model 700. FIG. 7B shows a series of poses 760, 762, 764, and 766. The initial two poses 760 and 762 are optimal poses. Two additional poses 764 and 766 are added to the pose sequence with every additional stair. When the multi-stair terrain has uniformed stair runs and rises, the additional poses 764 and 766 can be repeated from the poses 762 and 764 for each additional stair without the requirement to solve repetitively as illustrated in FIG. 7B.

The formal nonlinear programming problem (NLP) of the pose optimization is defined as follows:

$$\text{?}$$

$$\text{?} \text{indicates text missing or illegible when filed}$$

The objective of the pose optimization is to find the optimal pose i at pose location \dot{p}_{c}^{ref}=[x_{c}^{ref},z_{c}^{ref}]^{T}, the reference pose location is resulted from the terrain information. Hence, the cost function Jᵢ aims to find the closest possible location that satisfy the given NLP constraints. In this optimization framework, kinematic constraints are used, therefore, a feasible pose solution Xᵢ should contain CoM 2D locations x_{c} and z_{c}, body pitch angle θ, and limb joint angles q*=[q₁, q₂, q₃, q₄]^{T}. Q is a diagonal weighting matrix. It is necessary to allow CoM z-direction location delta z_{c}^{ref}−z_{c} to have certain flexibility in order to solve for the most optimal poses. Thus, the weight in the z-direction location delta is chosen to be much smaller than that of x-direction location delta.

The optimization problem is subjected to several nonlinear constraints, shown in equation (19) to (22). The rim of each wheel is defined as the ground contact geometry whose geometry location p_{wheel} can be derived by forward kinematics (FK) with optimization variables Xᵢ. The rim of the wheel is constrained by equation (19) to be on the terrain in each pose. In equation (20), the x-direction of the rear wheel ground contact location p_{rw,x} is constrained to be less than that of rear hip p_{rh,x}. Both of these locations can be derived by FK with Xᵢ. This allows a larger support region in optimal poses, to prevent the robot from falling backward due to significantly large pitch angle during the task. Equation (21) can be implemented by integer programming in NLP. A custom function InCollision based on one point-line interception is applied here to determine whether the collision model is in contact with the terrain model (i.e., the collision model should always be above terrain). The location of the collision model point cloud p_{cm} is determined by FK. Lastly, in equation (22), the joint angles q* in the optimization variable are bounded by the physical joint limits of the hardware platform.

After the optimal poses are solved for a task, real-time pose planning is used in order to command desired joint angle and pitch angle online. The joint angle and pitch angle trajectory are linearly interpolated from an initial pose to intermediate optimal poses, and then to the final pose. The general interpolation equation at time t from pose i (qᵢ and Oi) to pose i+1 (_{qi+1} and Oi+1) with a transition phase Δt is as follows,

$$\text{?}$$

$$\text{?} \text{indicates text missing or illegible when filed}$$

Where t_{0,i} is the initial time of transition from pose i to pose i+1. Since the optimization outputs only optimal joint and pitch angles, the tracking controller 344 is needed to enable the robot to perform a certain pose at a desired location and timing. The optimal poses q* are tracked by the joint PD tracking controller 344, while the optimal pitch angle θ* is tracked by the QP balancing controller 340. The timing of each pose \hat{t}1 and \hat{t}2 is estimated by the current average wheel joint speed \overline{\dot{q}} wheel and terrain stair slope angle γ and height h,

$${\hat{t}}_{1} = t + \frac{( Δ x - {R}_{wheel} )}{{R}_{wheel} {{q}^{\overline{˙}}}_{wheel}} \qquad ( 25 )$$

$${\hat{t}}_{2} = {\hat{t}}_{1} + \frac{( \frac{h}{sin ( γ )} + {R}_{wheel} )}{{R}_{wheel} {{q}^{\overline{˙}}}_{wheel}} \qquad ( 26 )$$

Where t is the current timing at the start of estimation.

$$τ = {τ}_{QP} + {K}_{q , p} ( q * - q ) + {K}_{q , p} ( \dot{q} * - \dot{q} ) \qquad ( 27 )$$

The tracking controller 344 works alongside the QP force-based balance controller 340 to balance the robot while the robot is rolling over high obstacles. This approach is also applied in well-established tracking controller with motion planning and control. Using the example hybrid joint PD and QP force-based control has been successful in quadruped jumping control. The example hybrid control enabled a quadruped robot to jump on a 76 cm height desk. The summation torques from the joint PD tracking controller 344 and QP force balance controller 340 may be used to control the robot to roll over high obstacles. The resulting control input T in terms of joint torques for thigh and calf joints is a combination of torque T_{QP} determined by the balance controller 340 and the tracking controller 344, as shown in equation (27) above.

The following experimental data is provided to better illustrate the claimed invention and is not intended to be interpreted as limiting the scope. In particular, hardware experiment results with the example control system are summarized below. The pose optimization framework may be implemented by any one of many modern NLP solvers. An example pose optimization was implemented and executed in MATLAB fmincon Sequential Quadratic Programming (SQP) solver for the simulation and hardware experiments. The offline computation time for a single-stair pose optimization task is in the range of 0.3 s to 0.5 s. As a benchmark, the PC hardware platform used for offline motion planning included an AMD Ryzen 5-5600X CPU clocked at 4.65 GHz. The computation cost is expected to be scaled down further when the pose optimization is implemented in a C++ based solver, such as IPOPT in the future.

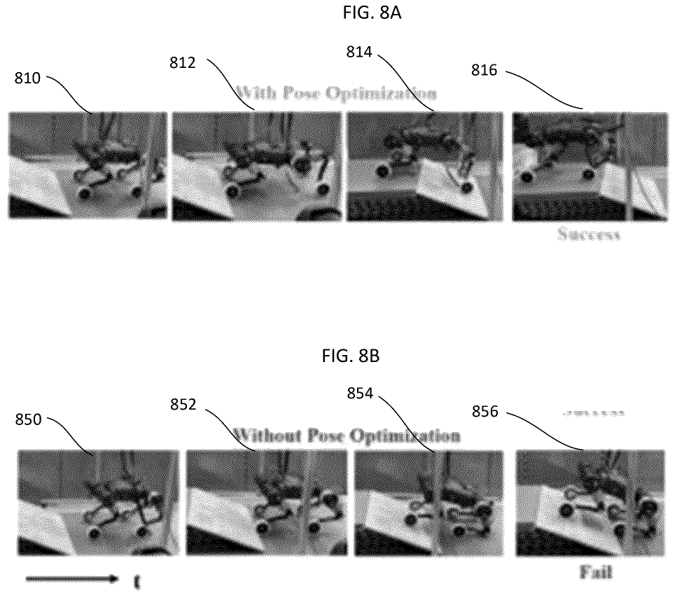

In hardware experiments, the incorporation of pose optimization has been validated on the robotic hardware and has also shown its advantages compared to without pose optimization. FIG. 8A-8B shows snapshots of experiment results comparing the performance of these two approaches. In one experiment, the robot was commanded to roll up a very simple 0.25 m high ramp with a slope angle of 30°. FIG. 8A shows a series of snapshots 810, 812, 814, and 816 from an initial pose in snapshot 810 to a successful final pose in snapshot 816 when the robot was controlled with pose optimization. FIG. 8B shows a series of snapshots 850, 852, 854, and 856 from an initial pose in snapshot 850 to a failed final pose in snapshot 866 when the robot was controlled without the pose optimization routine.

It was observed that using the nominal quadruped pose (without pose optimization in FIG. 8B), the CoM location falls towards the back of the leg support region and causes significant pitch angle error. In addition, the leg configuration does not favor traversing over slopes due to the collision of rear calf joints and the ground. In contrast, the example method using pose optimization allows the CoM location to stay centered at the support region and body pitch angle is minimal as shown in FIG. 8A.

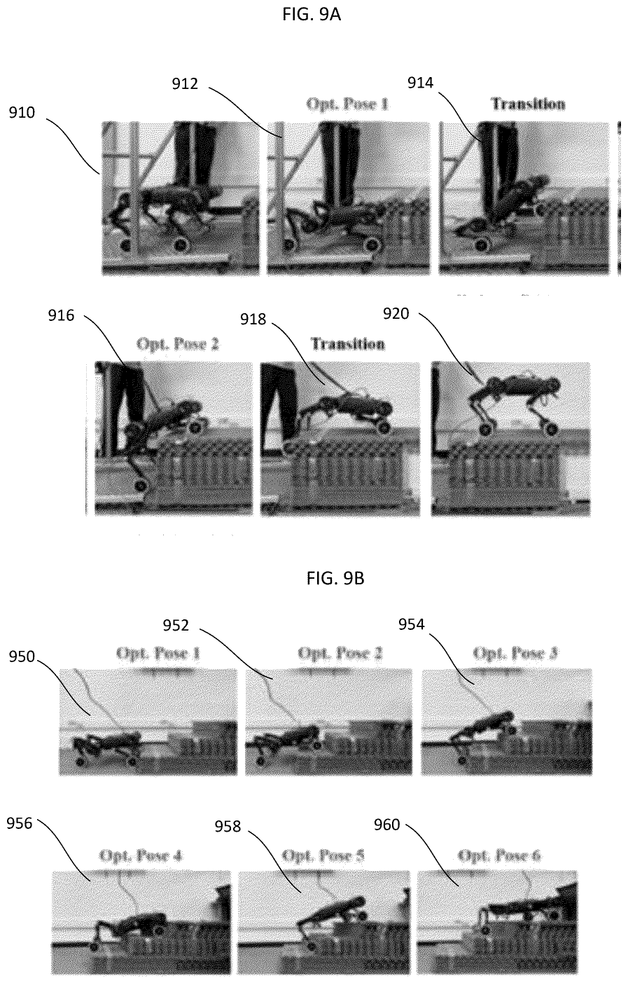

The example method was demonstrated in single-stair and 3-stair obstacle experiments. FIG. 9A shows a series of snapshots of an experiment of driving the robot up one stair with a height of 0.36 m. FIG. 9B shows a series of snapshots of an experiment of driving the robot up 3 consecutive stairs with height of 0.125 m and a run of 0.30 m. The example robot hardware controlled by the hybrid control architecture successfully achieved climbing up a 0.36 m stair. A nominal quadruped robot gait cannot climb up such a high stair because it is constrained by the nominal height of the robot. As a reference, the nominal standing height of the example wheel-legged robot is 0.33 m. FIG. 9A includes a series of snapshots 910, 912, 914, 916, 918, and 920 of this experiment. The robot starts with an initial pose as shown in the snapshot 910. The robot moves to a first optimal pose as shown in the snapshot 912. The snapshot 914 shows a transition to a second optimal pose as shown in the snapshot 916.

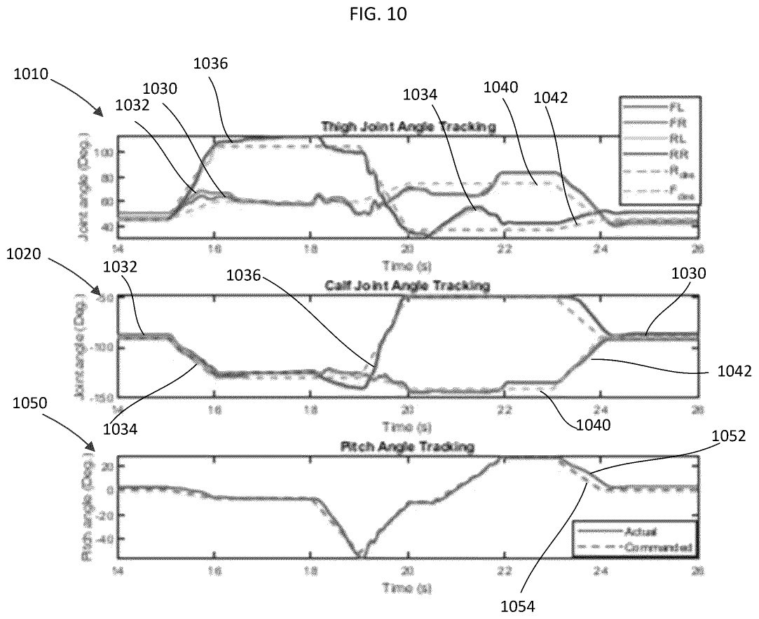

The pitch and joint angle tracking plots of this successful single-stair experiment with pose optimization in FIG. 9A are shown in FIG. 10. FIG. 10 shows a plot 1010 of thigh joint angle tracking over time for movement of the robot in the single stair task. A plot 1020 shows a calf joint angle tracking over time for movement of the robot in the single stair task. In the plots 1010 and 1020, the solid lines 1030, 1032, 1034, and 1036 represent the calf joint angles for each leg (front left, FL; front right, FR; rear right, RR; and rear left, RL respectively). The dashed lines 1040 and 1042 represent the desired/commanded angles for the front and rear legs respectively. A plot 1030 shows a pitch angle tracking over time for movement of the robot in the single stair task. The plot 1050 includes a solid trace 1052 of the actual pitch angle compared with a trace 1054 of the commanded pitch angle. The poses in FIG. 9A and the plots in FIG. 10 demonstrate the effectiveness of the example balancing control technique described herein.

FIG. 9B shows a series of snapshots 950, 952, 954, 956, 958, and 960 of an experiment of driving the robot over three stairs. In this experiment, each stair has a stair rise of 0.125 m and stair run of 0.30 m. Each of the snapshots 950, 952, 954, 956, 958, and 960 show an optimal pose position as the robot traverses the three stairs. This experiment validates the versatility of the pose optimization framework in a 3-consecutive-stair task.

The methods and systems described herein provide an effective approach of balancing the 12 degree of freedom wheel-legged robot with QP force-based control that employs modified simplified dynamics that considers the effects of wheel dynamics. Further, by leveraging the wheel traction in high obstacle terrain locomotion, the optimization method discussed above provides in motion planning that solves for favorable poses during stair-climbing tasks. The optimal poses are tracked by the joint PD tracking controller, along with QP balancing controller. In hardware implementation, the example robot is capable of climbing up on a 0.36 m stair (higher than the nominal height of the robot). The versatility of the pose optimization framework is validated through successful multi-stair task experiments and proven to have superior performance as compared to normal quadruped poses during such tasks.

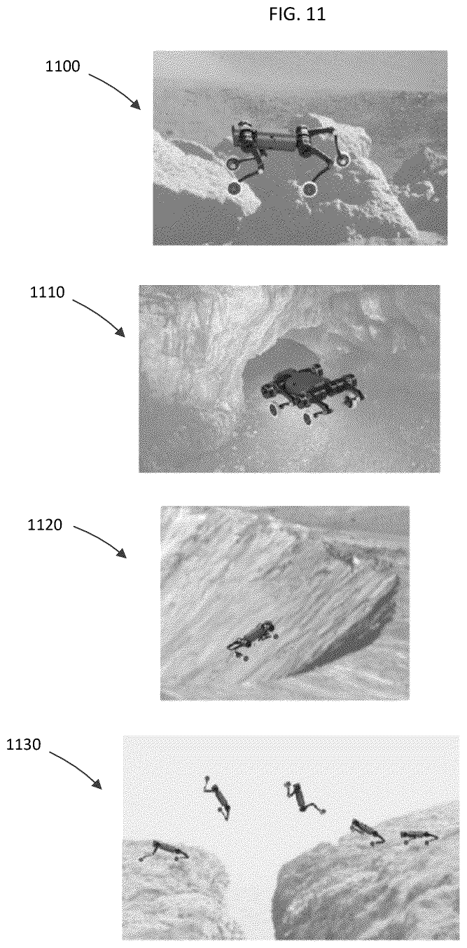

FIG. 11 shows a number of different scenarios for using the example robot control for varied terrain conditions for the ROLLER1 robot. For example, the ROLLER1 robot can combine walking and rolling on rocky terrain, rolling while crawling to go through a small opening, rolling on a steep slope or jumping through a large gap. FIG. 11 includes a first view 1100 that shows an example robot with the example hybrid control system to utilize the legs and rolling capability to traverse through a terrain with scattered moon rocks. A second view 1110 shows example the robot lowering its body to roll through a small cave in the terrain. A third view 1120 shows the example robot utilizing wheels to drive out of a crater in the terrain. A fourth view 1130 shows the example robot combining rolling and jumping capabilities to jump through a gap in the terrain.

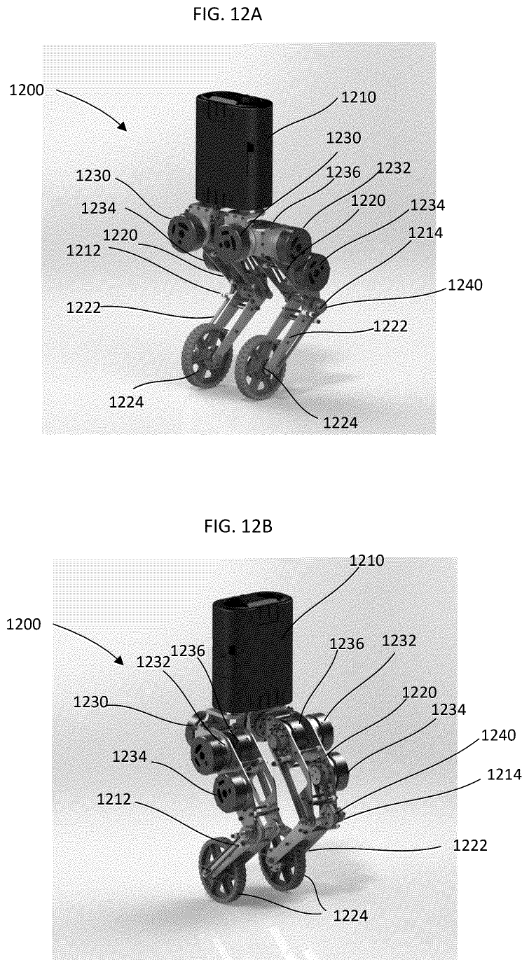

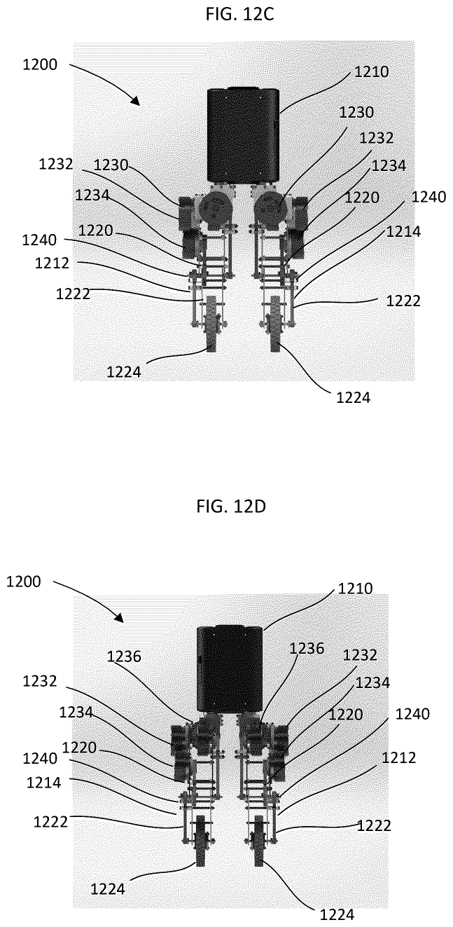

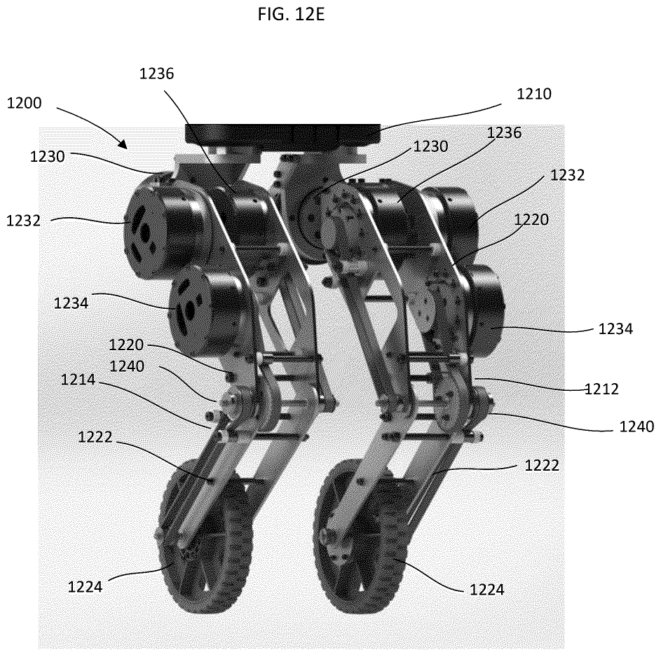

Although the example hybrid control system and pose optimization routine are applied to a four wheel-leg robot, the controllers may be modified for robots having different numbers of legs. For example, the design philosophy explained herein may be extended to a bipedal form robot. FIG. 12A shows a front perspective view and FIG. 12B shows a back perspective view of an example two wheel-leg robot 1200. FIG. 12C is a front view of the robot 1200 and FIG. 12D is a rear view of the robot 1200. FIG. 12E is a close up perspective view of the drive assembly for the robot 1200. The two wheel-legged robot 1200 includes a trunk enclosure 1210, and two four degrees of freedom (DoF) legs 1212 and 1214. Actuators 1230 allow each of the legs 1212 and 1214 to be rolled. Each of the legs 1212 and 1214 includes a thigh link assembly 1220, a calf link assembly 1222, and a wheel 1224 that are all actuated by actuators 1232, 1234, and 1236 respectively. The actuators 1230, 1232, 1234, and 1236 are controlled by the robot control system. In total, the example two wheel-legged robot 1200 has eight actuators for the two legs 1212 and 1214.

The trunk enclosure 1210 encloses components such as a power supply, a control system, a transceiver, payload and sensor support components. The hybrid control system and pose optimization routine in FIG. 4 allows the robot 1200 to traverse uneven terrain with large obstacles. The thigh link assembly 1220 is rotatably coupled to a calf joint 1240. One end of the calf link assembly 1222 thus may be rotated on the calf joint 1240. An opposite end of the calf link assembly 1222 supports the wheel 1224. The actuator 1232 rotates the thigh link assembly 1220. The actuator 1234 rotates the calf assembly 1222 around the calf joint 1240 via a pulley and timing belt. The actuator 1236 rotates the wheel 1224 through a two stage timing belt and associated pulleys.

The example bipedal wheel-legged robot 1200 is designed to combine the advantages of both bipedal and wheeled locomotion through a hybrid control scheme explained above in relation to the architecture 400 in FIG. 4. The control scheme and pose optimization explained in FIG. 4 is modified to account for the roll angle of the legs 1212 and 1214. Thus, the controller for the robot 1200 will output another set of torque values for the actuators 1230. By using wheels for efficient traversal over flat or smooth terrain, and legs for more complex tasks and navigation over rough or uneven surfaces, the robot 1200 can achieve a high degree of adaptability to various environments.

The power transmission system of the robot 1200 follows a similar design to the previous model, with the motor located close to the torso to minimize inertia and timing belts and pulleys utilized for power transmission. This design provides the robot 1200 with a stable and efficient power source for its movements. The design of the robot 1200 allows for adjustments to the gear ratio and the size of the wheel, which enables it to achieve higher speeds while rolling. The robot's ability to make sharp turns and navigate tight spaces makes it highly maneuverable in complex environments.

To minimize production costs, the design of the example robot 1200 utilizes cost-efficient manufacturing methods such as laser cutting. This ensures that the robot is accessible to a wider range of users and can be produced at scale. Overall, the example bipedal wheel-legged robot 1200 is designed to be a versatile and adaptable machine, capable of performing a wide variety of tasks in various environments, while maintaining stability, maneuverability, and energy efficiency. Laser cutting the parts of the robot 1200 result in a generally light weight robot, which allows less unwanted dynamic effect of the legs in the system and lowers motor torque limit requirements during balancing control and navigating high obstacles.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

1. A method for operating a wheel-legged robot, the method comprising:
determining, via a balancing controller, one or more of a desired thigh joint torque for a thigh of a leg of the wheel-legged robot and a desired calf joint torque for a calf of the wheel leg of the wheel-legged robot, the thigh coupled to the calf via the calf joint;
determining, via a rolling controller, a desired wheel torque for a wheel of the wheel leg of the wheel-legged robot based on one or more of a wheel traction and yaw, the wheel coupled to the calf via a wheel joint; and
operating one or more a calf motor, a thigh motor, and a wheel motor of the wheel leg according to the desired thigh joint torque, the desired calf joint torque, and the desired wheel torque.

2. The method of claim 1, wherein the wheel torque is based on a wheel traction force and a desired yaw speed.

3. The method of claim 1, wherein the desired thigh joint torque, the desired calf joint torque, and the desired wheel torque is based on a center of mass location for the wheel-legged robot.

4. The method of claim 1, further comprising performing pose optimization based on one or more terrain parameters and updating one or more of the desired thigh joint torque, the desired calf joint torque, and the desired wheel torque via a tracking controller based on pitch angle and joint angles of a pose.

5. The method of claim 4, wherein the pose optimization is performed via a nonlinear programming (NLP) model subject to forward kinematic constraints and collision avoidance with a terrain model.

6. The method of claim 5, wherein the forward kinematic constraints include wheel contact and wheel direction.

7. The method of claim 4, wherein the terrain parameters are determined by a terrain sensor.

8. The method of claim 4, wherein the pitch angle and joint angles are linearly interpolated from an initial pose to an intermediate pose and from the intermediate pose to a final pose.

9. The method of claim 1, further comprising deriving a center of mass (CoM) position, velocity, pitch angle θ_{des} and angular velocity input for a path through terrain from commands of an input device and wherein the desired thigh joint torque and calf joint torque are determined from the commands of the input device.

10. The method of claim 10, wherein the input device is one of a human input controller, an autonomous controller, or a semi-autonomous controller.

11. A wheel-legged robot comprising:
a set of wheel legs, each wheel leg including a thigh actuator rotating a thigh link, a calf actuator rotating a calf link coupled to the thigh link, and a wheel actuator rotating a wheel coupled to the calf link;
an input to accept a command for the wheel-legged robot to traverse;
a balancing controller coupled to each of the wheel legs and coupled to the input, the balancing controller determining a desired thigh joint torque for each thigh link and a desired calf joint torque and operating the calf actuators and thigh actuators according to the desired torques;
a rolling controller coupled each of the wheel legs and the input, the rolling controller determining a desired wheel torque for each wheel based on one or more of a wheel traction and yaw, and operating the wheel actuators according to the desired wheel torque.

12. The wheel-legged robot of claim 11, further comprising:
a pose optimization controller performing pose optimization of the robot based on one or more terrain parameters, and outputting desired joint angles for the calves and thighs; and
a tracking controller updating one or more of the desired thigh joint torque, the desired calf joint torque, and the desired wheel torque based on the desired joint angles.

13. The wheel-legged robot of claim 12, wherein the pose optimization is performed via a nonlinear programming (NLP) model subject to forward kinematic constraints and collision avoidance with a terrain model.

14. The wheel-legged robot of claim 11, further comprising an enclosure with a power source and a payload compartment.

15. The wheel-legged robot of claim 11, wherein each of the actuators are motors.

16. The wheel-legged robot of claim 11, further comprising an input device coupled to the input, wherein the input device accepts commands and derives a center of mass (CoM) position, velocity, pitch angle θ_{des} and angular velocity input for a path through terrain from the commands, and wherein the desired thigh joint torque and calf joint torque are determined from the input device.

17. The wheel-legged robot of claim 16, wherein the input device is one of a human input controller, an autonomous controller, or a semi-autonomous controller.

18. (canceled)

19. A non-transitory, machine readable medium having stored thereon instructions for controlled a wheel-legged robot, the stored instructions comprising machine executable code, which when executed by at least one machine processor, causes the machine processor to:
determine one or more of a desired thigh joint torque for a thigh of a leg of the wheel-legged robot and a desired calf joint torque for a calf of the wheel leg of the wheel-legged robot, the thigh coupled to the calf via the calf joint;
determine a desired wheel torque for a wheel of the wheel leg of the wheel-legged robot based on one or more of a wheel traction and yaw, the wheel coupled to the calf via a wheel joint; and
operate one or more a calf actuator, a thigh actuator, and a wheel actuator of the wheel leg according to the desired thigh joint torque, the desired calf joint torque, and the desired wheel torque.

20-26. (canceled)

27. The wheel-legged robot of claim 11, wherein the wheel torque is based on a wheel traction force and a desired yaw speed, and wherein the desired thigh joint torque, the desired calf joint torque, and the desired wheel torque is based on a center of mass location for the wheel-legged robot.

28. The wheel-legged robot of claim 12, wherein the pitch angle and joint angles are linearly interpolated from an initial pose to an intermediate pose and from the intermediate pose to a final pose.
